(19) United States
(12) Patent Application Publication
(10) Pub. No.: US 2011/0235222 A1
(43) Pub. Date: Sep. 29, 2011

(54) OUTPUT SHORT TO GROUND PROTECTION CIRCUIT

(75) Inventors: Wee Sien HONG, Singapore (SG); Weijie LI, Singapore (SG); Guo Lei YU, Singapore (SG)

(73) Assignees: PANASONIC CORPORATION, Osaka (JP); PANASONIC SEMICONDUCTOR ASIA PTE. LTD., Singapore (SG)

(21) Appl. No.: 12/732,292

(22) Filed: Mar. 26, 2010

(51) Int. Cl. H02H 9/08

(52) U.S. Cl. 361/42

(57) ABSTRACT

An output short to ground protection circuit protects an electronic device when it is short circuited to ground. The protection circuit has an NMOS transistor coupled to the output power transistor. A fixed voltage generator is connected to a gate terminal of the NMOS transistor. A first voltage clamping circuit and a second voltage clamping circuit are provided. The voltage clamping circuits are utilized so as to limit the current outputted by the output power transistor when the short circuit occurs.

### BACKGROUND OF THE INVENTION

The present invention relates to a current limit and output short to ground protection circuit, making use of voltage clamping circuitry.

Normally, for electronic devices such as power amplifier ICs and voltage regulator ICs, an abnormal situation, when it occurred, may affect such ICs. One of such situations may occur when its output pin is short circuited to ground. When this happens, there will be a large current flow through its power transistor. This situation can damage the device and the power supply circuit to the device. In order to prevent this problem, many devices would incorporate a protection circuit for protecting an output terminal from being short circuited to ground, which is herein also referred to as an output short to ground protection circuit, or simply a protection circuit. Such a protection circuit typically functions to turn off output stage upon the occurrence of the abnormal situation. However, in other types of protection circuits, it just limits current instead of turning off the output stage.

The output short to ground protection circuit has two types of methods to detect output short to ground. One is by monitoring the output voltage, and the other is detecting current through output stage. The present invention relates to the method of monitoring the output voltage.

A typical circuit to detect output short to ground by monitoring the output voltage is as shown in FIG. 1. Comparator 101 monitors the output terminal by comparing the output voltage with a pre-determined reference low voltage, Vref. For the condition where the output is short circuited to ground, the output voltage will drop below Vref. This causes comparator 101 to output a signal to a controller 100. Upon receipt of the signal, controller 100 will further send a voltage signal to the gate of power NMOS transistor M1 so as to cause power NMOS transistor M1 to stop conducting or limit its current conduction.

Though this circuit is effective, it has the drawback of taking a large implementation area. That is, more circuit elements, hence more mask area, are required for this circuit. This has the disadvantage of extra costs incurred on the IC manufacturer.

The present invention is intended to solve such problems, and it is an object of the present invention to provide a current limiting type output short to ground protection circuit that utilizes less circuit elements.

### SUMMARY OF THE INVENTION

The purpose of this invention is to limit output current during IC start-up or when the output pin is short circuited to ground.

The present invention makes use of voltage clamping circuitry to limit output current.

According to one embodiment of the present invention, an output short to ground protection circuit for an electronic device having an output power transistor, an output terminal and a capacitor connected between the output terminal and the ground, said protection circuit comprises: an NMOS transistor having a drain terminal connected to a gate terminal of the output power transistor; a fixed voltage generator connected to a gate terminal of the NMOS transistor; a first voltage clamping circuit having a first terminal connected to the gate terminal of the output power transistor and a second terminal connected to a source terminal of the NMOS transistor; and a second voltage clamping circuit having a first terminal connected to said source terminal of said NMOS transistor and second terminal connected to the output terminal.

### BRIEF DESCRIPTION OF THE DRAWINGS

FIG. 1 is a block diagram showing the conventional circuitry of output short to ground protection circuit.

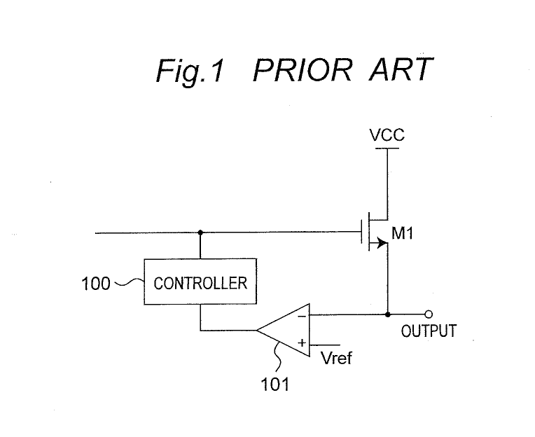

FIG. 2 is a block diagram showing the first embodiment of the present invention.

FIG. 3 is a block diagram showing the second embodiment of the present invention.

### DETAILED DESCRIPTION OF THE PREFERRED EMBODIMENTS

The following description explains the best mode embodiment of the present invention.

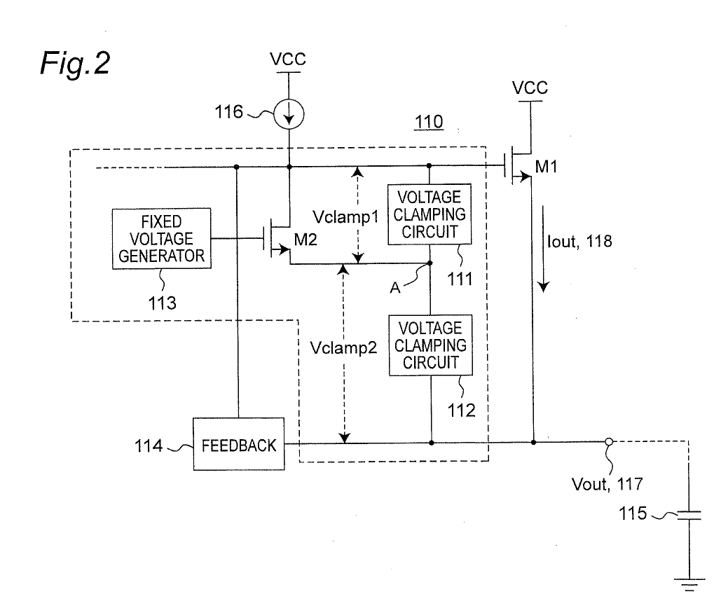

Referring to FIG. 2, a first embodiment of an output short to ground protection circuit is shown.

Based on a first embodiment of the present invention, the output short to ground protection circuit 110 comprises voltage clamping circuits 111 and 112, fixed voltage generator 113, and NMOS transistor M2.

Fixed voltage generator 113 may typically be in the form of a voltage regulator or a voltage reference circuit. The fixed voltage generator 113 serves to provide a fixed voltage for biasing NMOS transistor M2 via its gate terminal.

One of the two terminals of voltage clamping circuit 111 is connected to the gate terminal of NMOS transistor M1, whereas the other terminal is connected to the source terminal of NMOS transistor M2.

One of the two terminals of voltage clamping circuit 112 is connected to the source terminal of NMOS transistor M2, whereas the other terminal is connected to the output terminal, Vₒᵤₜ 117.

Further provided is an electronic device having a current source 116 connected to the gate terminal of NMOS transistor M1, a feedback block 114 connected between output terminal Vₒᵤₜ 117 and the gate terminal of NMOS transistor M1, and a capacitor 115 connected between output terminal Vₒᵤₜ 117 and the ground.

The operation of the first embodiment of the present invention is as follows.

In FIG. 2, the potential at node A between voltage clamping circuits 111 and 112 is represented as:

V_{A}=V_{clamp2}+Vₒᵤₜ.

Upon startup, voltage at the output terminal Vₒᵤₜ 117 is low (Vₒᵤₜ 117≈0), due to capacitor 115 still in the process of being charged up. Hence, V_{A} is fixed by voltage clamping circuit 112 to V_{clamp2}. Fixed voltage from fixed voltage generator 113 serves to bias the gate of NMOS transistor M2 so as to cause it to conduct when the potential at the output terminal, Vₒᵤₜ 117 is low. That is, V_{A}≈V_{clamp2}. The fixed voltage from the fixed voltage generator 113 is less than V_{clamp2}+Vₒᵤₜ+V_{th,M2}, where V_{th,M2} is the threshold voltage of NMOS transistor M2.

Effectively, this means that the voltage between gate and source of NMOS transistor M1, V_{GS,M1} is equal to V_{A}≈V_{clamp2}. This has the effect of limiting the output current, Iₒᵤₜ 118.

Upon gradual charging of capacitor 115, the potential at the output terminal Vout 117 will increase as well.

V_{A} will correspondingly rise to become equal to V_{clamp2}+Vₒᵤₜ, which is high enough to cause NMOS transistor M2 to turn off. As a result

V_{GS,M1}=V_{clamp1}+V_{clamp2},

where V_{clamp1} is the potential difference between node A and the gate terminal of NMOS transistor M1, as a result of voltage clamping circuit 111. The resultant current of Iout 118 as a result V_{GS,M1}=V_{clamp1}+V_{clamp2} is the current under normal working conditions.

For a condition where the output terminal Vₒᵤₜ 117 is short circuited to ground, the same condition as that produced at the startup is produced. Thus, V_{A}≈V_{clamp2}, causing NMOS transistor M2 to turn on. This results in V_{GS,M1}=V_{clamp2}, thus limiting the current Iout 118.

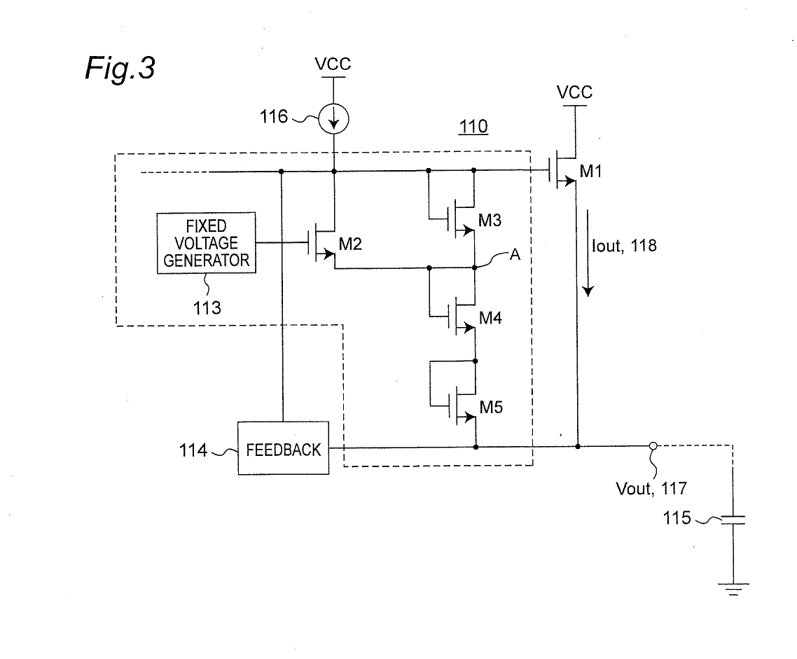

A second embodiment of the present invention is shown in FIG. 3. Here, voltage clamping circuit 111 is replaced with NMOS transistor M3, and voltage clamping circuit 112 is replaced with NMOS transistors M4 and M5.

As can be seen in FIG. 3, the gate terminal of NMOS transistor M3 is connected to its drain terminal, which is further connected to the gate terminal of NMOS transistor M1.

The gate terminal of NMOS M4 is connected to its drain terminal, which is further connected to the source terminal of NMOS transistor M2. The source terminal of NMOS transistor M4 is connected to the drain terminal of NMOS transistor M5.

The gate terminal of NMOS transistor M5 is connected to its drain terminal, whereas its source terminal is connected to the output terminal, Vₒᵤₜ 117.

Hence,

V_{clamp1}=V_{GS,M3}

V_{clamp2}=V_{GS,M4}+V_{GS,M5}.

NMOS transistor M3 is a diode connected transistor (or a diode connection transistor). Similarly, each of NMOS transistors M4 and M5 is a diode connected transistor. The number of the diode connected transistor for the voltage clamping circuit 111 is at least one, and the number of the diode connected transistor for the voltage clamping circuit 112 is at least one.

The operation of the second embodiment is similar to that of the first embodiment.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1. An output short to ground protection circuit for an electronic device having an output power transistor, an output terminal and a capacitor connected between the output terminal and a ground, said protection circuit comprising:
an NMOS transistor having a drain terminal connected to a gate terminal of the output power transistor;
a fixed voltage generator connected to a gate terminal of the NMOS transistor;
a first voltage clamping circuit having a first terminal connected to the gate terminal of the output power transistor and a second terminal connected to a source terminal of the NMOS transistor; and
a second voltage clamping circuit having a first terminal connected to said source terminal of said NMOS transistor and second terminal connected to the output terminal.

2. The output short to ground protection circuit for an electronic device according to claim 1, wherein said first voltage clamping circuit comprises at least one diode connected transistor.

3. The output short to ground protection circuit for an electronic device according to claim 1, wherein said second voltage clamping circuit comprises at least one diode connected transistor.

4. The output short to ground protection circuit for an electronic device according to claim 1, wherein said fixed voltage generator is a voltage reference circuit.

5. The output short to ground protection circuit for an electronic device according to claim 1, wherein said fixed voltage generator is a voltage regulator.

6. A method of protecting an electronic device from an output short circuit to ground condition by an output short to ground protection circuit, said electronic device having: an output power transistor; an output terminal; and a capacitor connected between the output terminal and a ground, and said output short to ground protection circuit having: an NMOS transistor having a drain terminal connected to a gate terminal of the output power transistor; a fixed voltage generator connected to a gate terminal of the NMOS transistor; a first voltage clamping circuit having a first terminal connected to the gate terminal of the output power transistor and a second terminal connected to a source terminal of the NMOS transistor; and a second voltage clamping circuit having a first terminal connected to said source terminal of said NMOS transistor and second terminal connected to the output terminal, the method comprising:
biasing the gate terminal of said NMOS transistor with a potential so as to make the NMOS transistor turn off under normal working conditions;
clamping a first potential between said output terminal and the source terminal of said NMOS transistor;
clamping a second potential between said drain and source terminals of said NMOS transistor; and
turning on of said NMOS transistor, thus disregarding the second clamp potential, when the output terminal is short circuited to ground.

7. The method of protecting an electronic device from an output short to ground condition according to claim 6, wherein said clamping is performed by using at least one diode connected transistor.

8. The method of protecting an electronic device from an output short to ground condition according to claim 6, wherein said biasing is performed by using a voltage regulator.

9. The method of protecting an electronic device from an output short to ground condition according to claim 6, wherein said biasing is performed by using a voltage reference circuit.
